(19) United States
(12) Patent Application Publication
(10) Pub. No.: US 2021/0312080 A1
(43) Pub. Date: Oct. 7, 2021

(54) METHODOLOGY TO OBFUSCATE SENSITIVE INFORMATION IN MOBILE APPLICATION BACKGROUND SNAPSHOT

(71) Applicant: Visa International Service Association, San Francisco, CA (US)

(72) Inventor: Rakesh Ramamurthy, Bangalore (IN)

(21) Appl. No.: 17/269,770

(22) PCT Filed: Aug. 28, 2018
(86) PCT No.: PCT/US2018/048295

§ 371 Date: Feb. 19, 2021

(51) Int. Cl. G06F 21/62; G06F 9/451

(52) U.S. Cl. CPC G06F 21/6245; G06F 9/451

(57) ABSTRACT

Techniques described herein are directed to a system which prevents unintended data leakage by intelligently masking/obfuscating sensitive data by carefully listening for application lifecycle events and acting upon those events. The system may manipulate the data which will be displayed just before the creation of a snapshot by the OS. The system may identify all data fields from the last-seen screen for the software application which are marked as sensitive and then obfuscate those data fields. Thus, the system can mask the sensitive data that appears in the last-seen screen, such that any snapshot taken during this time, all the sensitive fields will be obfuscated. Once the application enters to the foreground state completely, reverse logic can be applied for removing the masking to present actual data. Thus, the system maintains the security of sensitive data while minimizing any impact on the user experience.

### CROSS-REFERENCE TO RELATED APPLICATIONS

None.

### BACKGROUND

Unintended data leakage can occur when a developer inadvertently places sensitive information or data in a location on a mobile device that is easily accessible by other apps on that mobile device. In particular, data leakage can occur when a developer's code processes sensitive information supplied by the user or the backend. During that processing, a side-effect (which may be unknown to the developer) may occur which results in the sensitive information being placed into an insecure location on the mobile device that other applications on the mobile device may have open access to. Typically, these side-effects are caused by the underlying mobile device's operating system (OS). This will be a very prevalent vulnerability for code produced by a developer that does not have intimate knowledge of how that information can be stored or processed by the underlying OS. It is easy to detect data leakage by inspecting all mobile device locations that are accessible to all apps for the app's sensitive information.

One such unintended data leakage can occur during ‘Application Backgrounding’ or ‘Application Multitasking’ where, upon a particular software application being minimized, the OS will save an image file representing the last screen displayed for that software application to provide a smoother experience to the user during application foreground switching by reducing any lag effect while providing the ability to identify that mobile application.

Embodiments of the present disclosure address these problems and other problems, individually and collectively.

### SUMMARY

One embodiment of the disclosure is directed to method of obfuscating sensitive information comprising: receiving, on a client device, an indication of a mobile application being executed upon the client device, identifying that the mobile application is associated with sensitive data, receiving an indication of a lifecycle event related to the mobile application being executed upon the client device, and upon determining that the lifecycle event will result in a data capture of the sensitive data, and prior to execution of the lifecycle event on the client device, obfuscating the sensitive data.

Another embodiment of the disclosure is directed to a client device comprising: a display, a processor, and a memory including instructions that, when executed with the processor, cause the client device to, at least: receive an indication of a mobile application being executed upon the client device, identify that the mobile application is associated with sensitive data, receive an indication of a lifecycle event related to the mobile application being executed upon the client device, and upon determining that the lifecycle event will result in a data capture of the sensitive data, and prior to execution of the lifecycle event on the client device, obfuscate the sensitive data.

### BRIEF DESCRIPTION OF THE DRAWINGS

Various embodiments in accordance with the present disclosure will be described with reference to the drawings, in which:

FIG. 1 depicts an illustrative example of a system that uses one or more techniques in accordance with the processes described herein;

FIG. 2 depicts an illustrative example of a system or architecture in which techniques for obfuscating sensitive data to prevent screen capture may be implemented;

FIG. 3 depicts a flow chart illustrating an example process for obfuscating sensitive mobile application data in accordance with at least some embodiments;

FIG. 4 depicts an illustrative example of a process that may be performed by an event listener in accordance with at least some embodiments;

FIG. 5 depicts a first exemplary obfuscation technique that may be used in accordance with at least some embodiments;

FIG. 6 depicts a second exemplary obfuscation technique that may be used in accordance with at least some embodiments; and

FIG. 7 depicts a flow diagram illustrating a process for protecting sensitive data from being recorded in a data capture event in accordance with at least some embodiments.

### DETAILED DESCRIPTION

Described herein are techniques for obfuscating sensitive data during a data capture lifecycle event in order to prevent unauthorized reproduction of that sensitive data. In some embodiments, the system described herein includes an event listener configured to detect lifecycle events and determine whether the detected lifecycle events are likely to result in a data capture. The system described herein may also include an obfuscation module and the event listener may be further configured to notify the obfuscation module of any detected data capture lifecycle events. The obfuscation module may then determine an appropriate means of obfuscating data to prevent its capture in the data capture lifecycle event and may subsequently employ that obfuscation means.

Prior to discussing specific embodiments of the invention, some terms may be described in detail.

A “computing device” may include any suitable device that can electronically process data. Examples of computing devices include desktop computers, mobile devices or mobile computing devices, television sets, etc.

A “data capture event” is any event that may result in a record of data values associated with at least one mobile application being created. For example, a screen capture event may be a type of data capture event in which a screenshot is taken of a current view of a mobile application's graphical user interface. In a screen capture event, the screenshot may be stored in memory and accessed later in order to obtain data values depicted within the screenshot. Data capture events may be initiated through a number of means. For example, a screenshot may be captured of a mobile application which is currently in focus as the mobile application is minimized. In this example, the screenshot may be displayed within a list of screenshots as a representation of the mobile application.

A “data field” may be any place in which data can be stored. A data field may refer to a column in a database, a field in a data entry form or a web form, or a field in a mobile application which stores a data value. The data field may contain data to be entered by a user as well as data to be displayed. In some embodiments, a data field may be associated with a particular display location. For example, a data field may be associated with a particular location within a graphical user interface (GUI) such that a value associated with the data field is displayed within that particular location. A sensitive data field may be any data field which stores information that is considered sensitive. In some non-limiting examples, data fields may include Image views, Buttons, Text Fields, or any other suitable data storage/presentation mechanism.

An “event” may be any action or occurrence recognized by software, often originating asynchronously from an environment external to the software, that may be handled by the software. A number of different types of events may be recognized by a particular device. By way of illustration, a “touch event” may be any event that represents one or more points of contact with a touch-sensitive surface, and changes of those points with respect to the surface and any elements displayed upon it (e.g. for touch screens) or associated with it (e.g. for drawing tablets without displays). Touch events may also include stylus-based events performed on pen-tablet devices, such as drawing tablets. In another example, a keystroke entered by a user into a keyboard may trigger an event.

An “event listener” is a procedure or function in a computer program that waits for an event to occur (e.g., a user clicking or moving the mouse, pressing a key on the keyboard, or an internal timer or interrupt). In some embodiments, the event listener may be a loop that is programmed to react to an input or signal. Event listeners may be configured to listen for a particular type of event. For example, an event listener may be configured to detect a screen capture event by detecting that a screen capture button has been pressed by a user.

A “mobile device” may include any portable electronic device capable of performing at least a portion of the functionality described herein. A mobile device may include at least a processor, a memory, and a display device capable of displaying information to a user. In some embodiments, a mobile device may be capable of communication with a number of other electronic devices. Mobile applications may be installed upon, and executed from the memory of, the mobile device to cause the mobile device to perform a number of functions. Some illustrative examples of a mobile device may include a cellular phone, personal data assistant (PDA), tablet device, or any other suitable device. A mobile device is an example of a client device.

An “lifecycle event” may be any suitable event which impacts the execution of an application such as a mobile application. For example, lifecycle events may occur when an application is launched, ended, or minimized (e.g., moved to the background). Lifecycle events may be initiated from the mobile application itself, from an operating system which executes the mobile application, or via some third party applications (applications not directly related to the mobile application). Some non-limiting examples of lifecycle events might be an “Application entered to back ground event,” an “Application resigns active state event,” an “Application entered to active state event,” an “Application entered to foreground event,” etc. It should be noted that a subset of the set of lifecycle events that can impact a mobile application may result in the operating system capturing a current state of the mobile application.

An “obstruction layer” may be any virtual object used to obfuscate a piece of data. In some embodiments, an obstruction layer may comprise one or more opaque areas to be displayed upon a display screen over the sensitive data. In some embodiments, an obstruction layer may be generated by identifying the location, size, and shape of sensitive data and generating a blocking object of the determined size and shape at the determined location.

An “operating system” may include any software that supports a computers basic functions, such as scheduling tasks, executing mobile applications, and controlling peripherals.

The term “sensitive information” may refer to any information that should be protected against unwarranted disclosure. Protection of sensitive information may be required for legal or ethical reasons, for issues pertaining to personal privacy, or for proprietary considerations.

A “user” may include an individual. In some embodiments, a user may be associated with one or more personal accounts and/or mobile devices. The user may also be referred to as a cardholder, account holder, or consumer.

Techniques described herein are directed to a system which prevents unintended data leakage by intelligently masking/obfuscating sensitive data by carefully listening to application life cycle events (e.g., an “Application entered to back ground event,” an “Application resigns active state event,” an “Application entered to active state event,” an “Application entered to foreground event,” etc.) and acting upon those events. More particularly, the life cycle events are acted upon using a custom screen reader which manipulates the data which will be displayed just before the creation of a snapshot by the OS. The intelligent obfuscation can be implemented by reading all the UI elements from the last-seen screen for the software application which are marked as sensitive, along with the pixel color used to render the information, and then refilling the marked sensitive UI element with obtained color. Thus, the system will mask the sensitive data that appears in the last-seen screen. For any snapshot taken by OS during this time, all the sensitive fields will be obfuscated. Once the application enters to the foreground state completely, we can apply reverse logic for removing the masking to present actual data. Thus, the system maintains the security of the sensitive data while minimizing any impact on the user experience.

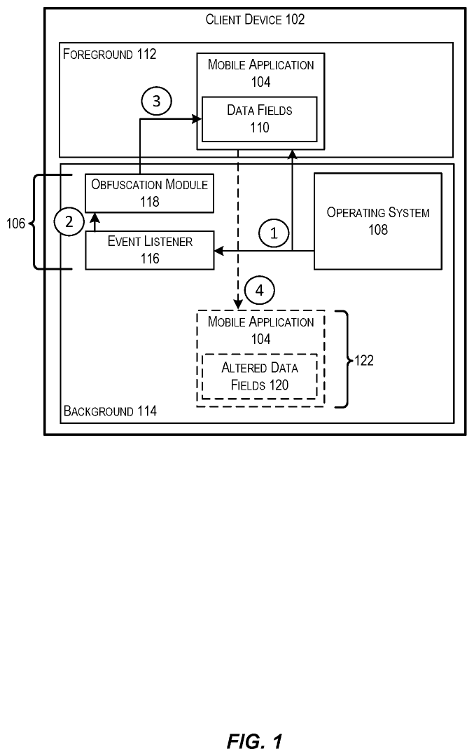

FIG. 1 depicts an illustrative example of a system that uses one or more techniques in accordance with the processes described herein. In FIG. 1, a client device 102 is depicted as including in its memory at least one mobile application 104, an obfuscation module 106, and an operating system 108. The mobile application 104 may include a number of data fields 110, some of which may be associated with sensitive information. Additionally, the client device 102 may have a foreground 112 which displays a mobile application 104 which is currently active, and a background 114 which maintains information on mobile applications which are running, but are not currently active.

In FIG. 1, the obfuscation module 106 may include at least an event listener 116 and an obfuscator 118. In this example, the event listener 116 may detect a lifecycle event at step 1. In some embodiments, the lifecycle event may be initiated by the operating system 108 (e.g., in response to an action received from a user of the client device 102). Upon detecting the lifecycle, the event listener 116 may determine whether the lifecycle event is one which will cause a screenshot to be captured of the current state of the mobile application 104. For example, the event listener 116 may determine if the lifecycle event is one which will result in the mobile application 104 being moved from the foreground 112 to the background 114 of the client device, which typically results in a screenshot of the current state of the mobile application being captured. The event listener 116 may be configured to report lifecycle events that will cause a screenshot to be captured to the obfuscator 118 at step 2. Lifecycle events that will cause a screenshot to be captured may vary according to the type/version of the client device 102 and/or the type/version of the operating system 108 installed on that client device 102. Hence, the event listener 116 may be customized for a particular client device 102 and/or operating system 108.

It should be noted that in some embodiments, the system may not include an obfuscator 118. In at least some of these embodiments, the event listener 116 may be configured to report relevant lifecycle events directly to any mobile application 104 running in the foreground of the client device 102, regardless of whether that mobile application 104 is configured to handle the reported events in the manners described throughout this disclosure. This would enable any software developer to create a mobile application 104 capable of performing the functionality described herein without the need for an update to the event listener 116 to account for that mobile application.

Once the obfuscator 118 has received an indication of a lifecycle event that will result in a screenshot, the obfuscator 118 may be configured to identify sensitive information to be obfuscated. In some embodiments, one or more data fields 110 associated with a mobile application 104 may be marked as including sensitive data. For example, a data field 110 for a mobile application 104 may include a metadata tag which indicates that the data field is sensitive in nature. Next, the obfuscator 118 may determine a location in the foreground for each of the data fields 110 that include sensitive information. Once the locations for each of the relevant data fields has been determined, the obfuscator 118 may be configured to obfuscate each of the identified fields. In some embodiments, the obfuscator 118 may be configured to cause the mobile application 104 to blank out or nullify the data in the identified data fields 110. However, it should be noted that this may require participation in the obfuscation process by the mobile application 104, which may not be ideal. In some embodiments, the obfuscator 118 may identify the locations of the identified data fields 110 within a graphical user interface (GUI) of the mobile application 104. In other words, the obfuscator 118 may determine the location in which the data fields are depicted on a display of the client device 102. In at least some of these embodiments, the obfuscator 118 may depict a block or other object over (i.e., in front of) the data field 110. In some embodiments, the obfuscator 118 may determine a field color of the data field (e.g., using color sampling techniques) and may generate a block of the same size, shape, and color of the data field 110. In this way, the obfuscator 118 may generate altered data fields 120 in which no sensitive data is visible.

The lifecycle event is then carried out by the operating system 108. In this example, the operating system captures a screenshot 122 of the foreground 112 of the client device at step 4 (e.g., when the mobile application 104 is moved into the background 114), which may be accessible to other applications. Because the screenshot 122 includes the altered data fields 120, other applications are not able to obtain sensitive data from the screenshot 122 of the mobile application 104.

For clarity, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the internet), using any suitable communication protocol.

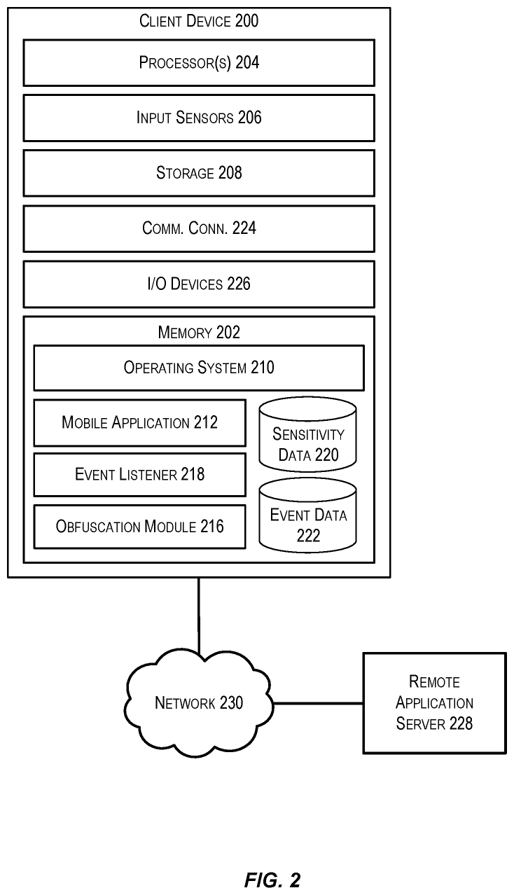

FIG. 2 depicts an illustrative example of a system or architecture in which techniques for obfuscating sensitive data to prevent screen capture may be implemented. In the depicted architecture, one or more consumers and/or users may utilize a client device 200, which may be an example of a client device 102 as depicted in FIG. 1. In some examples, the client device 200 may be in communication with a service provider computer which provides backend support for at least a portion of the functionality described herein.

The client device 200 may be any type of computing device such as, but not limited to, a mobile phone, a smart phone, a personal digital assistant (PDA), a laptop computer, a desktop computer, a server computer, a thin-client device, a tablet PC, etc. The client device 200 may include a memory 202 and one or more processors 204 capable of processing user input. The client device 200 may also include one or more input sensors 206 for receiving user input. As is known in the art, there are a variety of input sensors capable of detecting user input, such as accelerometers, cameras, microphones, etc. The user input obtained by the input sensors may be from a variety of data input types, including, but not limited to, audio data, visual data, or biometric data. In some embodiments, the input sensors 206 may include a “touch screen” display device, which may be used to convey information (e.g., a user signature) to the client device 200.

Embodiments of the application on the client device 200 may be stored and executed from its memory 202. The memory 202 may store program instructions that are loadable and executable on the processor(s) 204, as well as data generated during the execution of these programs. Depending on the configuration and type of client device 200, the memory 202 may be volatile (such as random access memory (RAM)) and/or non-volatile (such as read-only memory (ROM), flash memory, etc.). The client device 200 may also include additional storage 208, such as either removable storage or non-removable storage including, but not limited to, magnetic storage, optical disks, and/or tape storage. The disk drives and their associated computer-readable media may provide non-volatile storage of computer-readable instructions, data structures, program modules, and other data for the computing devices. In some implementations, the memory 202 may include multiple different types of memory, such as static random access memory (SRAM), dynamic random access memory (DRAM) or ROM. Turning to the contents of the memory 202 in more detail, the memory 202 may include an operating system 210 and one or more mobile application programs 212 or services for performing one or more functions using the client device 102. In some embodiments, the memory 202 may include a number of modules, or components, including a module for obfuscating sensitive data displayed by one or more mobile applications 212 (obfuscation module 216) and a module for detecting a potential screen capture lifecycle event (event listener 218). The memory 202 may also include information pertaining to a level of sensitivity for various mobile applications 212 and/or data fields for those applications (sensitivity data 220) as well as information pertaining to various types of events (event data 222).

It should be noted that although depicted as being separate from the mobile application 212, the obfuscation module 216 and/or the event listener 218 may be appended to, or included within, the mobile application 212. For example, at least a portion of the functionality described with respect to the obfuscation module 216 and/or the event listener 218 may be included in mobile application 212. In some embodiments, an original version of the mobile application 212 may be modified to include the obfuscation module 216 and/or the event listener 218. In some embodiments, the mobile application 212 may access at least a portion of the functionality provided by the obfuscation module 216 and/or the event listener 218 via an application programming interface (API). In some embodiments, this may be accomplished via the use of method calls or other techniques.

In some embodiments, the obfuscation module 216 may comprise code that, when executed in conjunction with the processors 204, causes the client device 200 to conceal, empty, or otherwise obfuscate data displayed with respect to certain mobile applications 212 and/or data fields associated with those mobile applications. In some embodiments, the obfuscation module 216 may identify a number of applications on the client device 200 which are considered to handle sensitive data. In some embodiments, applications that handle sensitive data may be indicated in a database table such as sensitivity data 220. In some embodiments, the obfuscation module 216 may maintain a list of sensitive applications specific to the client device 200. For example, the obfuscation module 216 may add applications to a list of applications that handle sensitive data as those applications are installed upon the client device 200 if those applications are determined to be of a particular application type or category (e.g., wallet applications). The obfuscation module 216 may determine, at any given time, which of these sensitive applications are currently displayed on a display of the client device 200 (e.g., in focus). In some embodiments, the obfuscation module 216 may maintain a logo or icon associated with each mobile application in a list of sensitive mobile applications. For example, when an application is installed upon, or executed upon, the client device 200, that application (or a remote server in communication with that application) may create a piece of data (e.g., an internet cookie) to be stored on the client device 200 that includes some sort of imagery to be associated with the mobile application (e.g., card art, a logo, etc.). In this example, the obfuscation module 216 may retrieve and associate the imagery with the mobile application.

In some embodiments, the obfuscation module 216 may be implemented within a mobile application 212. In at least some of these embodiments, upon receiving an indication that a data capture event has been detected (e.g., via the event listener) the obfuscation module 216 may determine what type of obfuscation is appropriate for each of a number of data fields identified as including sensitive data that are currently displayed by the client device 200. For example, the obfuscation module 216 may determine whether it is appropriate to empty out, or nullify, a data field. In another example, the obfuscation module 216 may determine whether it is appropriate to place an obstruction layer over the data displayed in the data field. In this example, the obfuscation module 216 may generate an obstruction layer of a size and shape sufficient to conceal the sensitive data which may then be placed in the location of the sensitive data such that it is displayed over the sensitive data. In some embodiments, the obfuscation module 216 may be configured to cancel any active data input events, resulting in nullifying any data fields that are currently being entered. The obfuscation module 216 may be configured to maintain the obfuscation of the data fields until the screen capture event has concluded (e.g., as indicated by the event listener). Examples of embodiments in which an obfuscation module 216 may be implemented within a mobile application are disclosed in more detail in PCT Patent Application No. PCT/US18/48274 entitled “METHODOLOGY TO PREVENT SCREEN CAPTURE OF SENSITIVE DATA IN MOBILE APPS,” filed on Aug. 28, 2018 and which is herein incorporated by reference in its entirety.

In some embodiments, the obfuscation module 216 may be implemented as an application that runs in the background of a client device 200 and which is configured to cause a mobile application 212 running in the foreground of that client device 200 to be obfuscated upon detecting a data capture event. In at least some of these embodiments, the obfuscation module 216 may be configured to identify a mobile application currently running in the foreground of the client device 200, identify an appropriate obfuscation means applicable to the identified mobile application, and cause that mobile application to be obfuscated using the determined means. In some scenarios, the obfuscation module 216 may select an image associated with the mobile application and may cause that image to be displayed over a graphical user interface (GUI) associated with the mobile application 212 until the detected data capture event has been completed.

In some embodiments, the event listener 218 may comprise code that, when executed in conjunction with the processors 204, detect an event that is likely to result in a data-capture action (i.e., a screen capture event). In some embodiments, the event listener 218 may detect all lifecycle events pertaining to applications running on the client device 200 (e.g., application minimization event, change focus event, application termination event etc.) and may determine whether those detected events will result in a data capture. In some embodiments, a list of events which result in a data capture may be maintained in event data 222. In these embodiments, the event listener 218 may be configured to listen for events matching those indicated in event data 222 as resulting in a data capture. Upon detecting a data capture event, the event listener 218 may report the event to the obfuscation module 216 (which may be included in a mobile application 212 running in the foreground of client device 200 or included in a separate application executing in the background of client device 200).

In some embodiments, the event listener 218 may be further configured to report the conclusion of a data capture event to the obfuscation module 216. For example, the event listener may, upon determining that a data capture event has completed, report the conclusion of the data capture event to the obfuscation module 216 to cause the obfuscation module 216 to reveal any obfuscated data.

It should be noted that, in some embodiments, one or more of the obfuscation module 216 and/or the event listener 218 may be separate from the mobile application 212. In some embodiments, the mobile application 212 may be modified (i.e., “modded” or extended) to include one or more of the obfuscation module 216 and/or the event listener 218 after installation of the mobile application 212 onto the client device 200. In some embodiments, one or more of the obfuscation module 216 and/or the event listener 218 may be a small program which is separate from the mobile application 212 (e.g., a widget or applet) and accessed by the mobile application 212 to perform the functions described above.

The memory 202 and any additional storage, both removable and non-removable, are examples of non-transitory computer-readable storage media. For example, computer-readable storage media may include volatile or non-volatile, removable or non-removable media implemented in any method or technology for storage of information such as computer-readable instructions, data structures, program modules or other data. As used herein, modules may refer to programming modules executed by computing systems (e.g., processors) that are part of the client device 200. In some embodiments, modules may refer to hardware modules. For example, at least a portion of the functionality described herein may be implemented as an integrated circuit of the client device 200. By way of illustration, a portion of the functionality may be implemented via a Field Programmable Gate Array (FPGA), application-specific integrated circuit (ASIC), or any other suitable hardware module. The client device 200 may also contain communications connections 224 that allow the client device 200 to communicate with a stored database, another computing device or server, user terminals, and/or other devices on the network 208. The client device 200 may also include input/output (I/O) device(s) and/or ports 226, such as for enabling connection with a keyboard, a mouse, a pen, a voice input device, a touch input device, a display, speakers, a printer, etc.

In some embodiments, the client device 200 may be in communication with one or more additional electronic devices to perform at least a portion of the functionality described herein. For example, the client device 200 may be in communication with a remote application server 228 via a network connection 230.

In some embodiments, a remote application server 228 may be any computing device that provides backend support for at least one application executing on the client device 200. For example, a portion of the functionality attributed to the obfuscation module 216 and/or mobile application 212 may be performed on the remote application server 228. In some embodiments, one or more of the sensitivity data 220 or the event data 222 stored in memory 202 may be updated by the remote application server 228 (e.g., via a software update). For example, the remote server 228 may provide an updated list of mobile applications that handle sensitive data as the remote server 228 becomes aware of new mobile applications.

The network 230 may be any suitable communication network or combination of networks. Suitable communications networks may include any one or a combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

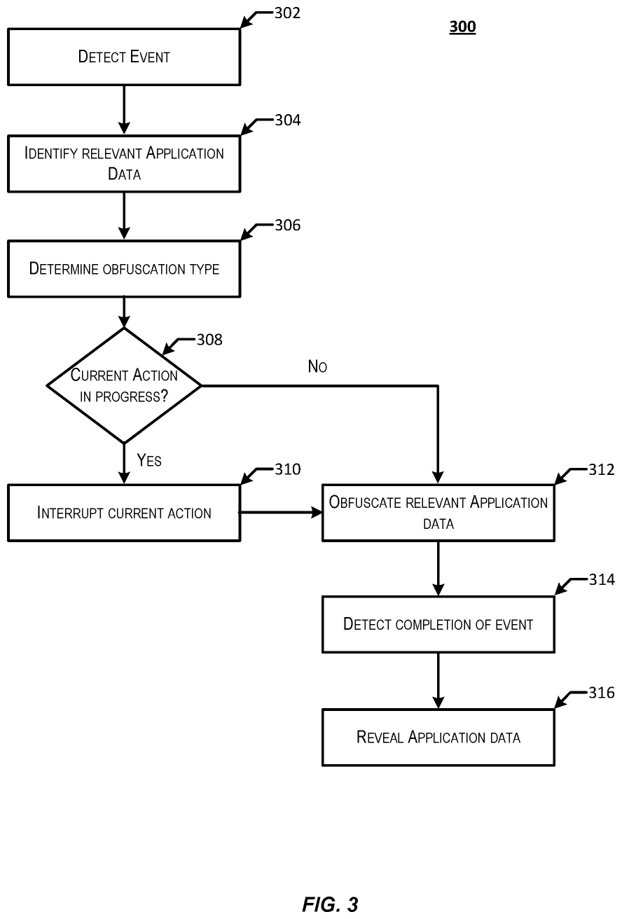

FIG. 3 depicts a flow chart illustrating an example process for obfuscating sensitive mobile application data in accordance with at least some embodiments. In some embodiments, the process 300 depicted in FIG. 3 may be performed by a client device such as client device 200 of FIG. 2. In particular, the process 300 may be performed by an obfuscation module such as the obfuscation module 216 depicted in FIG. 2.

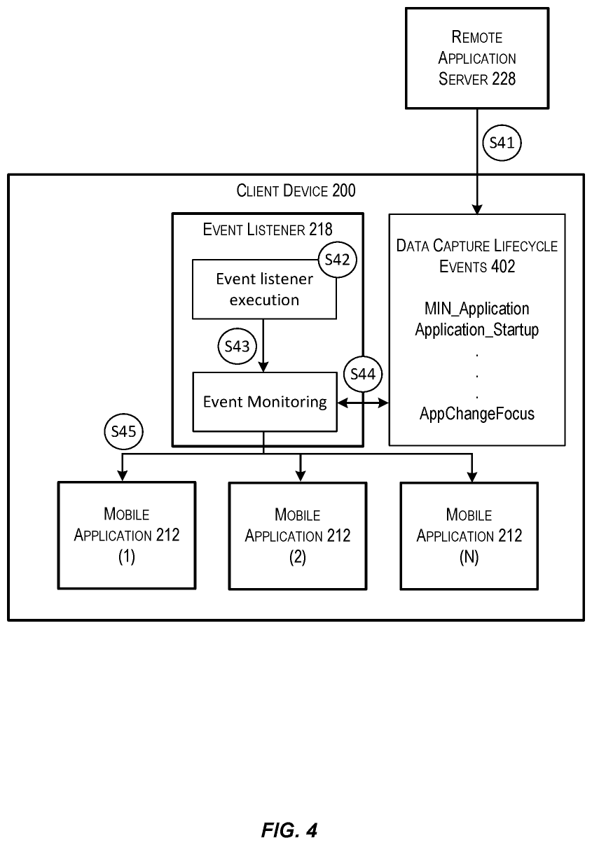

The process 300 may begin at 302, when a data capture lifecycle event (e.g., an application minimization event) is detected. In some embodiments, the event may be detected via an event listener and reported to an obfuscation module. In some embodiments, the event may be identified as a data capture event based on it matching an event type indicated as being a data capture event in a list referenced by the event listener. A process for detecting and identifying data capture lifecycle events is described in greater detail with respect to FIG. 4 below.

At 304, the process 300 may involve identifying a number of relevant mobile applications that handle sensitive information and/or data fields within mobile applications that include sensitive data. In some embodiments, relevant mobile applications may be determined based on application sensitivity information stored on the client device. In some embodiments, each mobile application may be associated with a particular level of sensitivity, such that different mobile applications may be determined to be relevant to different types of data capturing events. In some embodiments, only the mobile application running in the foreground of the client device may be determined to be relevant.

At 306, the process may involve determining, for each of the identified relevant mobile application and/or data fields, an appropriate form of obfuscation to be applied. In some cases, it may be appropriate to nullify or remove data from a data field. In another example, an obstruction layer may be generated that is of an appropriate size to conceal a GUI for the mobile application or data within a particular data field. In this example, the obstruction layer may be placed so that it obstructs a view of the sensitive data. In some embodiments, the obstruction layer may be generated to include imagery associated with the mobile application. In some embodiments, the obstruction layer may be generated as a blocking object which matches a color and/or style of an area surround the blocking object.

At 308, the process may determine whether a data input action is currently being taken with respect to a mobile application running in the foreground of the client device. If a data input action is currently underway, that action may be interrupted at 310 in order to provide the obfuscation functionality described herein. By way of example, at the time that a data capture event is detected, a user may be entering data into a data field for a mobile application via a touch event. In this example, the touch event may be canceled, resulting in a nullification of the data entered into the data field via the touch event. In some embodiments, further user input actions may be prevented for the mobile application until completion of the data capture event. For example, touch actions may be disabled and/or data fields may be locked to prevent further sensitive data from being provided. In another example, focus may be shifted away from the mobile application in order to prevent further actions to be completed with respect to the mobile application.

At 312, the process may involve obfuscating the identified relevant sensitive data. In some embodiments, this may involve obfuscating the mobile application data which is currently displayed on the display device. In some embodiments, this may involve determining which data fields associated with a mobile application are populated with data which is currently depicted on the screen of the display and obfuscating those data fields. In some embodiments, this may involve displaying a number of obstruction layers in front of, or over, the mobile application itself or each relevant data field associated with that mobile application. In the case that particular data fields are obfuscated, each of the generated obstruction layers may be configured to maintain their position over their respective data fields (e.g., as display data is scrolled). For example, each obstruction layer may move with the data field if the GUI is scrolled. Hence, in the event that the data capture event is a video recording event, sensitive data in the data fields will continue to be obfuscated even as the user scrolls through the GUI.

At 314, the process 300 may involve detecting a conclusion of the data capture event. In some embodiments, this may involve determining that the data capture has been completed. In some embodiments, this may involve determining that an executable program responsible for capturing the data is no longer being executed. In some embodiments, once the data capture event is determined to be concluded, the process may involve revealing data within the previously-obfuscated sensitive data at 316. In some embodiments, this may involve removing any previously-placed obstruction layers. In some embodiments, any mobile applications, or data fields, that have been locked from further user input may be unlocked so that a user is able to enter data into those data fields.

FIG. 4 depicts an illustrative example of a process that may be performed by an event listener in accordance with at least some embodiments. In some embodiments, a client device 200 that includes the event listener 218 and a number of mobile applications 212 (1-N) may be in communication with a remote application server 228. Each of these components may be examples of their respective corresponding components described with respect to FIG. 2 above. It should be noted that the event listener 218 may be executed in the background of a client device 200 while a mobile application 212 is executing in the foreground. In some embodiments, an event listener 218 may be common to the number of mobile applications 212, in that the event listener 218 may report events to any mobile application that is currently being executed (or currently in focus).

In some embodiments, the client device 200 may store an indication of a number of different types of data capture lifecycle events (e.g., within an event database 222). For example, the client device 200 may maintain a list that includes indications of data capture lifecycle events 402. In some embodiments, these indications may be stored as a “blacklist” or “whitelist,” which include identifiers that can be used to determine whether a detected lifecycle event is a data capture lifecycle event. In some embodiments, the data stored in 402 may be updated by a remote application server 228 as the remote application server 228 becomes aware of new data capture lifecycle events. For example, upon identifying a new means of shifting focus away from a mobile application, the remote application server may update the data 402 to include an identifier for that new lifecycle event at step S41. In this example, the updated information may be provided in any suitable manner (e.g., push notification) to the client device 200.

At step S42, an event listener 218 may be executed on the client device 200. In some embodiments, this may involve a user of the client device 200 selecting and opening an icon associated with the event listener 218 on the screen of the client device. In some embodiments, the mobile application 212 may be a browser application and the event listener 218 may be an applet or other small program that is executed upon the user visiting a particular webpage. In some embodiments, the event listener 218 may be executed automatically upon startup of the client device 200.

Upon execution of the event listener 218, the event listener may begin monitoring for lifecycle events. In some cases, the event listener 218 may determine if a lifecycle event is currently in progress. Upon determining that a lifecycle event is not currently in progress, the event listener 218 may enter an event monitoring mode at step S43. In this event monitoring mode, the event listener 218 may detect each lifecycle event as it occurs and determine whether the detected lifecycle event is a data capture lifecycle event. In some cases, this may involve comparing the detected event to a number of known data capture lifecycle events 402 at step S44. In some embodiments, the event listener 218 may continue in the event monitoring mode until execution of the event listener 218 is ended.

At step S45, the event listener 218 may provide a notification to one or more mobile applications 212 to cause sensitive data to be obfuscated. In some embodiments, one or more mobile applications 212 may include an obfuscation module as described elsewhere. In at least some of these embodiments, the event listener 218 may be configured to report a detected data capture lifecycle event to each of the mobile applications 212. In some embodiments, the event listener 218 may be configured to provide a notification of a data capture lifecycle event to the mobile application which is currently in focus on the client device 200. For example, although a number of mobile applications may be executing on the client device, only one application may be executing in the foreground at any given time. In this example, other mobile applications may be executing in the background of the client device or may be minimized. In the above situation, the event listener 218 may provide a notification to the mobile application 212 which is currently running in the foreground of the client device. It should be noted that the mobile application 212 may or may not include an obfuscation module as described elsewhere. If the mobile application 212 does include an obfuscation module as described, then that obfuscation module may cause any sensitive data to be obfuscated. If the mobile application 212 does not include an obfuscation module as described, then the mobile application 212 may simply ignore the notification provide by the event listener 218.

In some embodiments, an obfuscation module may be separate from the one or more mobile applications 212. In at least some of these embodiments, the event listener, at step S45, may provide a notification to the obfuscation module. The obfuscation module may, upon receiving the notification be configured to identify a mobile application having current focus and to obfuscate that mobile application. It should be noted that the mobile application 212 being obfuscated need not be an active participant in the obfuscation performed by the obfuscation module. For example, upon receiving an indication of a data capture lifecycle event, the obfuscation module may identify the mobile application having current focus, identify a relevant imagery associated with that mobile application, and automatically display the identified imagery over the mobile application.

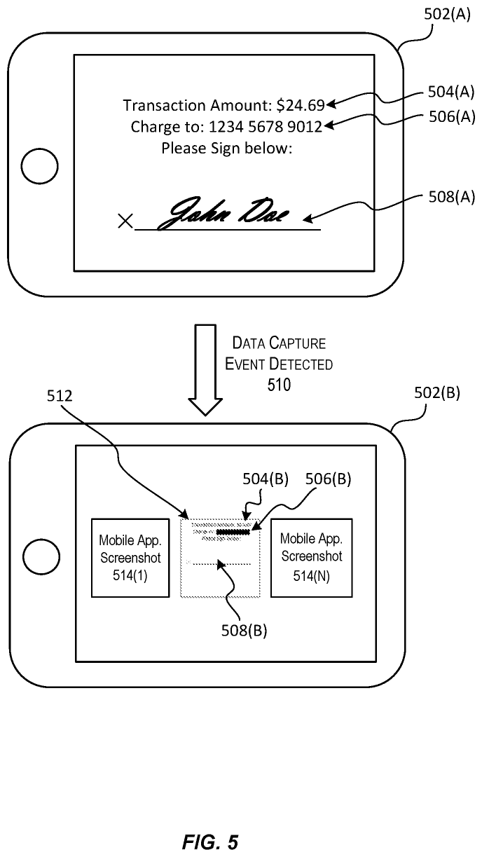

FIG. 5 depicts a first exemplary obfuscation technique that may be used in accordance with at least some embodiments. In FIG. 5, a client device 502 is depicted both before detection of a data capture event at 502(A) and after completion of the data capture event at 502(B). In particular, FIG. 5 depicts an illustrative process by which particular data fields within GUI of a mobile application may be obfuscated. The GUI includes a number of components (e.g., data fields) which are positioned according to a layout defined in a container associated with the GUI. It should be noted that while the data fields depicted in GUI are depicted as text fields, the data fields may include any object in which data values may be stored and displayed. For example, data fields may also include buttons, image views, etc.

As depicted, the client device 502 may display, via a display screen, a graphical user interface associated with a mobile application. In some embodiments, the mobile application may include a number of data fields 504, 506, and 508, for which a data value associated with data field may be displayed. Some of the data fields may be sensitive in nature, whereas some of the data fields may not be sensitive. For example, in the depicted illustration, a data field 504(A) associated with a transaction amount may not be determined to be sensitive, whereas a data field 506(A) associated with a primary account number (PAN), and a data field 508(A) associated with a signature block may each be determined to be sensitive. In the depicted example, only data values associated with data fields 506 and 508 (those determined to be sensitive) may be obfuscated.

As depicted at 510, a data capture lifecycle event may be detected on the client device 502. Upon detection of, and prior to completion of, the data capture event at 510, data values associated with data fields determined to be sensitive may be obfuscated. In the depicted example, data fields 506(B) and 508(B) are depicted as being obfuscated using different techniques. In particular, data field 506(B) is depicted as being obfuscated by placing an obstruction layer over the data value associated with the data field 506(B). In contrast, data field 508(B), which may be associated with recording a touch event, has been nullified (e.g., the data value has been removed from the data field). In some embodiments, when a data capture lifecycle event is detected while data is being entered using a touch event, the touch event may be canceled, causing any entered data to be removed.

In the depicted example, upon obfuscating the data using the various obfuscation techniques, the data capture event may be completed on the client device 502(B) resulting in a screen capture 512 (or other suitable data record) being generated to include the obfuscated data fields. In some embodiments, the screen capture 512 may be depicted alongside representations of other mobile applications (e.g., screenshots 514 (1-N)) being executed on the same client device.

It should be noted that the examples illustrated in FIG. 5 are intended to be non-limiting in nature. One skilled in the art would recognize a number of additional ways in which data may be obfuscated which may be considered equivalent to the techniques presented. Additionally, although the obstruction layer is depicted as being an opaque object, an obstruction layer may be used which is semi-transparent. For example, an obstruction layer may allow a portion of the data value to be viewed while making the data value unreadable (e.g., by distorting the data value).

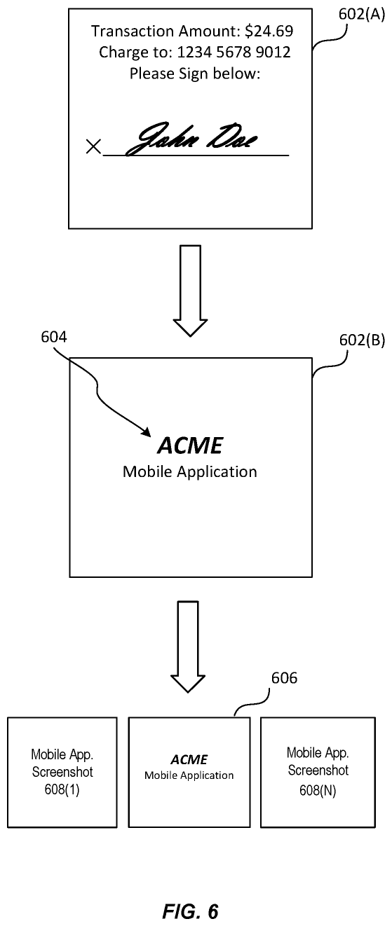

FIG. 6 depicts a second exemplary obfuscation technique that may be used in accordance with at least some embodiments. In FIG. 6, a graphical user interface (GUI) 602 is presented with respect to a mobile application. In particular, FIG. 6 depicts an illustrative process by which a mobile application may be obfuscated with or without involvement by that mobile application.

In some embodiments, the obfuscation module may be in communication with a container associated with the GUI of a mobile application. In some embodiments, the obfuscation module may not be in communication with the mobile application. The mobile application may be determined to handle sensitive data based on it being identified from a list of mobile applications handling sensitive data stored on the client device (e.g., sensitivity data 220 depicted in FIG. 2).

In embodiments in which the obfuscation module is not in communication with the mobile application, the obfuscation module may be configured to identify imagery 604 associated with the mobile application. In these embodiments, upon detecting a data capture lifecycle event, the obfuscation module may cause the imagery to be displayed over the mobile application for the duration of the detected event. In some embodiments, imagery associated with a particular mobile application may be provided to the client device by a remote server or by an operator of the mobile application. In some embodiments, an obstruction layer may be displayed over the mobile application that is not specific to the mobile application (e.g., a plain or patterned area), for example, when imagery is not available for a mobile application.

In embodiments in which the obfuscation module is in communication with the mobile application, the functionality of the container associated with the GUI 602 may be extended to include at least a portion of the functionality described herein. In particular, the container associated with the GUI 602 may be further configured to display an obstruction layer that conceals sensitive data displayed upon the screen of the client device. For example, in some embodiments, the container may be caused to obfuscate particular data fields that include sensitive data. This process is described in greater detail above with respect to FIG. 5. In another example, the obfuscation module may cause the container to display imagery 604 associated with the mobile application. In some embodiments, the imagery 604 may be stored by the mobile application in order to be displayed upon receiving instructions from the obfuscation module.

Once the data capture lifecycle event is determined to have been completed, the obstruction layer may be removed in order to reveal the previously-obfuscated sensitive data. In some embodiments, the mobile application will have been minimized (e.g., move to the background of the client device) and a screenshot 606 will have been captured of the current state of the mobile application. The screenshot 606 should then depict the obstruction layer (e.g., imagery associated with the mobile application) that was used to obfuscate the mobile application data. In some embodiments, the screenshot 606 may be presented within a set of screenshots 608 (1-N) each representing various mobile applications which have been minimized on the client device.

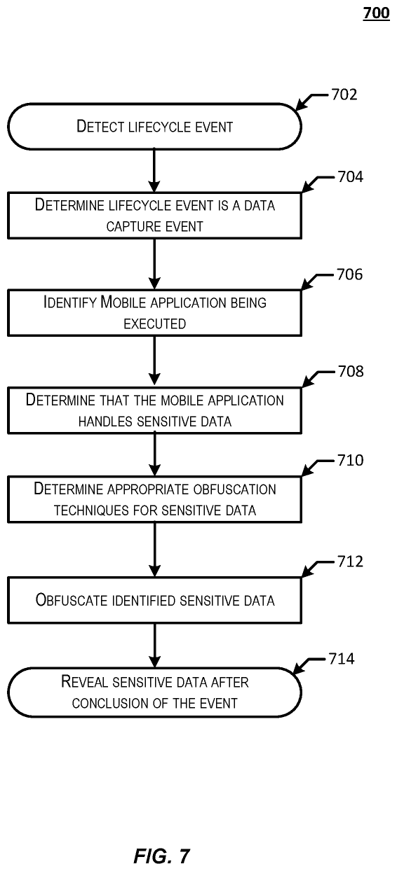

FIG. 7 depicts a flow diagram illustrating a process for protecting sensitive data from being recorded in a data capture event in accordance with at least some embodiments. In some embodiments, the process 700 may be performed by an obfuscation module as described elsewhere (e.g., obfuscation module 216 of FIG. 2).

Process 700 may begin at 702, when a lifecycle event is detected. In some embodiments, the lifecycle event may be detected by an event listener configured to receive data from an operating system of the device upon which the process 700 is being performed. As discussed elsewhere, a lifecycle event may include any event which impacts the execution of a mobile application which can be handled by the operating system. By way of non-limiting example, a lifecycle event may include any of an “Application entered to background event,” an “Application resigns active state event,” an “Application entered to active state event,” an “Application entered to foreground event,” etc.

At 704, the process may involve determining whether or not the lifecycle event is a data capture lifecycle event. In some embodiments, this determination may be made based at least in part on the lifecycle event being compared to a list of known data capture lifecycle events. In some embodiments, the list of known data capture lifecycle events may be provided by a remote application server to a device upon which the process 700 is being performed. For example, as the remote application server becomes aware of additional lifecycle event types that constitute data capture lifecycle events, the remote application server may provide an updated list of known data capture lifecycle events to each of the client devices that it supports. In some embodiments, the updated list of known data capture lifecycle events may be provided to one or more client devices via a push notification.

At 706, the process may involve identifying a mobile application which is currently being executed on the client device. In some embodiments, this may involve checking an application registry on the client device. The process may involve identifying the mobile application which is currently running in the foreground of the client device.

At 708, the process may involve determining whether the identified mobile application is one that handles sensitive data. In some embodiments, this determination may involve comparing an identifier for the mobile application to a list of mobile applications known to handle sensitive data. In some embodiments, the mobile application may self-identify as a mobile application that handles sensitive data. For example, upon execution of the mobile application, the mobile application may provide a notification to the event listener that it is being executed and that its data should be obfuscated. In some embodiments, the determination may be made based on a type or category associated with the mobile application. For example, it may be determined that the mobile application handles sensitive data upon determining that the mobile application is an e-wallet or payment application. In this example, the type or category associated with the mobile application may be derived from data stored in relation to the mobile application (e.g., a description or metadata tag).

Upon determining that the event is a data capture lifecycle event, and upon identifying a mobile application being executed, the process may further involve canceling one or more data input actions of the mobile application in order to enable mobile application data to be obfuscated. In some cases, this may cause any input already received with respect to an in-progress input action to be nullified. For example, if a user is currently providing, via a touch or keystroke event, a signature for a signature data field when the data capture lifecycle event is detected, the touch or keystroke event may be canceled. In this example, the portion of the user's signature which has already been entered may not be entered into the signature data field such that the data value in that data field remains null.

At 710, the process may involve determining an appropriate obfuscation technique to be used with the identified sensitive data. In some embodiments, it may be appropriate to conceal, remove, or nullify data included in a particular data field. In some embodiments, it may be appropriate to conceal an entire GUI associated with a particular mobile application. The appropriate obfuscation technique may involve generating an obstruction layer that will conceal the mobile application or at least one data value associated with the mobile application. In some embodiments, the process may also involve identifying positional information for each of a number of relevant mobile application data fields, which may be provided by a user interface container for that mobile application.

At 712, the process may involve obfuscating the identified sensitive data in the manner deemed appropriate. In some embodiments, this may involve generating an obstruction layer and rendering the obstruction layer so that it conceals the mobile application or at least one data value associated with the mobile application. To generate an obstruction layer, the process may involve creating blocking objects that will be displayed at a position corresponding to each of a number of relevant mobile application data fields. In some cases, this may be done by communicating with the GUI container associated with the mobile application. In some embodiments, an obstruction layer may comprise imagery associated with the mobile application (e.g., a logo, icon, or application name).

At 714, the process may involve revealing the obfuscated sensitive data upon determining that the lifecycle event has concluded. In some embodiments, the lifecycle event may be determined to be concluded when the event listener detects a conclusion of the lifecycle event. In some embodiments, revealing the obfuscated data fields may involve removing the obstruction layer concealing the sensitive data.

Embodiments of the system described herein result in a number of technical advantages over conventional systems. For example, the system described herein enables software developers to implement capabilities that are not typically able to be implemented for a number of mobile applications and which provide additional protection of a user's sensitive information. The system provides an efficient technique for obfuscating sensitive data which can be performed on any mobile application installed upon a client device.

Furthermore, embodiments of the disclosure provide a solution to a technological challenge faced by a number of issuers and mobile application developers. Namely, embodiments of the disclosure provide the ability to prevent sensitive data from being captured, and subsequently used, by unauthorized parties. It should be noted that functionality and capabilities of client devices are often at odds with data privacy, in that the developers of such functionality are often unaware of, or unconcerned with, the use of that functionality to capture sensitive data. For example, in most client devices, a data capture is performed when a mobile application is minimized in order to present a user with a means of quickly identifying an application to be restored. For example, when a user requests to access a running mobile application, the client device may present a number of screenshots which are each associated with a different mobile application that has been minimized. Each screen shot may depict the state of the mobile application upon its minimization. However, these screenshots can be accessed by other applications and any sensitive data included in a screenshot may be used by unauthorized parties. Embodiments of the current system enable a screenshot to be presented which still enables quick identification of the mobile application to be restored while protecting the user's sensitive data and providing security to that user.

A computer system may be used to implement any of the entities or components described above. The subsystems that may be included include system bus. Additional subsystems include a printer, keyboard, storage device, and monitor, which are coupled to display adapter. Peripherals and input/output (I/O) devices, which couple to I/O controller, can be connected to the computer system by any number of means known in the art, such as a serial port. For example, I/O port or external interface can be used to connect the computer apparatus to a wide area network such as the Internet, a mouse input device, or a scanner. The interconnection via system bus allows the central processor to communicate with each subsystem and to control the execution of instructions from system memory or the storage device, as well as the exchange of information between subsystems. The system memory and/or the storage device may embody a computer-readable medium.

As described, the inventive service may involve implementing one or more functions, processes, operations or method steps. In some embodiments, the functions, processes, operations or method steps may be implemented as a result of the execution of a set of instructions or software code by a suitably-programmed computing device, microprocessor, data processor, or the like. The set of instructions or software code may be stored in a memory or other form of data storage element which is accessed by the computing device, microprocessor, etc.

Any of the software components or functions described in this application may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read-only memory (ROM), a magnetic medium such as a hard-drive or a floppy disk, or an optical medium such as a CD-ROM. Any such computer-readable medium may reside on or within one or more computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method of obfuscating sensitive information comprising:
receiving, on a client device, an indication of a mobile application being executed upon the client device;
identifying that the mobile application is associated with sensitive data;
receiving an indication of a lifecycle event related to the mobile application being executed upon the client device; and
upon determining that the lifecycle event will result in a data capture of the sensitive data, and prior to execution of the lifecycle event on the client device, obfuscating the sensitive data.

2. The method of claim 1, wherein the indication of the lifecycle event is received from an event listener.

3. The method of claim 1, wherein obfuscating the sensitive data comprises causing a container of the mobile application being executed upon the client device to generate and display an obstruction layer.

4. The method of claim 3, wherein the obstruction layer conceals data fields that include the sensitive data.

5. The method of claim 4, wherein obfuscating the sensitive data comprises causing a GUI container associated with the mobile application to conceal the data fields that include the sensitive data.

6. The method of claim 1, wherein obfuscating the sensitive data comprises causing generating and displaying an obstruction layer over a GUI associated with the mobile application.

7. The method of claim 6, wherein the obstruction layer comprises imagery associated with the mobile application.

8. The method of claim 1, wherein identifying that the mobile application is associated with sensitive data comprises comparing an identifier for the mobile application to a list of mobile applications known to handle sensitive data.

9. The method of claim 8, wherein the list of mobile applications known to handle sensitive data is provided to the client device by a remote application server.

10. The method of claim 1, wherein the list of mobile applications known to handle sensitive data is provided by a remote application server.

11. A client device comprising:
a display;
a processor; and
a memory including instructions that, when executed with the processor, cause the client device to, at least:
receive an indication of a mobile application being executed upon the client device;
identify that the mobile application is associated with sensitive data;
receive an indication of a lifecycle event related to the mobile application being executed upon the client device; and
upon determining that the lifecycle event will result in a data capture of the sensitive data, and prior to execution of the lifecycle event on the client device, obfuscate the sensitive data.

12. The client device of claim 11, wherein the mobile application being executed upon the client device is a mobile application running in a foreground of the client device.

13. The client device of claim 12, wherein the lifecycle event is an event that will result in the execution of the mobile application being moved to a background of the client device.

14. The client device of claim 11, wherein the list of lifecycle events known to cause data capture is provided to the client device by a remote application server.

15. The client device of claim 11, wherein the mobile application is identified as being associated with sensitive data based on a type or category associated with the mobile application.

16. The client device of claim 11, wherein the instructions further cause the client device to reveal the data fields populated with sensitive information upon determining that the event has been completed.

17. The client device of claim 11, wherein the lifecycle event is a minimization of the mobile application.

18. The client device of claim 11, wherein the data capture of the sensitive data is a screenshot of a current state of the mobile application.

19. The client device of claim 18, wherein the screenshot is presented within a list of screenshots corresponding to other mobile applications.

20. The client device of claim 11, wherein determining that the lifecycle event will result in a data capture of the sensitive data comprises comparing the detected lifecycle event to a list of lifecycle events known to cause data capture.
